(19) United States
(12) Patent Application Publication
(10) Pub. No.: US 2014/0173835 A1
(43) Pub. Date: Jun. 26, 2014

(54) Mixtures of Reactive Dyes and Their Use

(71) Applicants: Georg Roentgen, Freiburg (DE); Athanassios Tzikas, Dornach (CH); Hubert Jean-Luc Christnacher, Dietwiller (FR); Laszlo Fekete, Magden (CH)

(72) Inventors: Georg Roentgen, Freiburg (DE); Athanassios Tzikas, Dornach (CH); Hubert Jean-Luc Christnacher, Dietwiller (FR); Laszlo Fekete, Magden (CH)

(73) Assignee: HUNTSMAN INTERNATIONAL LLC, The Woodlands, TX (US)

(21) Appl. No.: 14/236,364

(22) PCT Filed: Jun. 19, 2012
(86) PCT No.: PCT/EP2012/061643

§ 371 Date: Jan. 31, 2014

(30) Foreign Application Priority Data
Aug. 4, 2011 (EP) 11176525.1

(51) Int. Cl. C09B 62/533; C09B 62/513

(52) U.S. Cl. CPC C09B 62/533; C09B 62/513
USPC 8/549; 534/730

(57) ABSTRACT

Dye mixtures comprising at least one reactive dye of the formula (1) together with at least one reactive dye of the formula (2), wherein one of the radicals A and B denotes NH₂, and the other one of the radicals A and B denotes OH, D is a benzene or naphthalene radical, R₁ is hydrogen, hydroxy, sulfo, C₁-C₄alkyl or C₁-C₄alkoxy unsubstituted or substituted in the alkyl moiety by hydroxy or by sulfato, R₂ is hydrogen, C₁-C₄alkyl, C₁-C₄alkoxy, C₂-C₄alkanoylamino or ureido, R₃ is C₁-C₄alkyl, (R₄)₀₋₂ denotes 0 to 2 identical or different substituents selected from the group C₁-C₄alkyl, C₁-C₄alkoxy or sulfo, X1 is halogen, 3-carboxypyridin-1-yl or 3-carbamoylpyridin-1-yl, Y₁, Y₂, Y₃, Y₄ and Y₅ are each independently of the other vinyl or a radical —CH₂CH₂—U and U is a group removable under alkaline conditions, h, k, l, m and n are each independently of the other the number 0, 1 or 2, and p and q are each independently of the other the number 0 or 1, are suitable for dyeing and printing cellulosic or nitrogen-containing fibre materials.

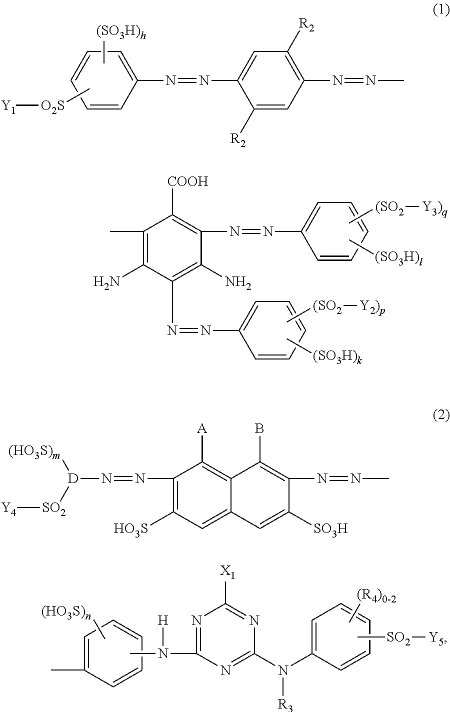

The present invention relates to mixtures of reactive dyes, especially, black- or navy-blue-dyeing mixtures that are suitable for the dyeing or printing of nitrogen-containing or hydroxyl-group-containing fibre materials and yield on such materials dyeings or prints having good reproducibility and good all-round fastness properties.

Over the past years, many countries have committed to improve the quality of the environment by saving natural resources and reducing the emission of substances which are harmful to the climate. Funds are provided by the governments to support the industry in achieving these goals. The consumer is asking for environmentally friendly textile products which are produced in accordance with highest ecological standards. Brands and retailers are conveying these demands into real requirements and textile manufacturers are continuously improving their production excellence by investing in modern equipment and selecting environmental friendly chemical substances.

As a result, there is a huge demand for novel reactive dye mixtures that are suitable for the reproducible dyeing and printing of fibre materials, which fulfill highest ecological and economical requirements while still providing dyeings of the desired colour shades with good fastness properties, such as wash and water fastness and perspiration fastness. Suitable reactive dyes should provide a unique combinability and a low sensitivity to various dyeing parameters. Furthermore, they should have sufficient substantivity and at the same time have good ease of washing off of unfixed dye. They should also have a good tinctorial yield and high reactivity, the objective being to provide especially dyeings having high degrees of fixing.

Black-dyeing or navy-blue-dyeing reactive dye mixtures are known, for example, from EP 0 600 322 A2, EP 1 134 260 A1, U.S. Pat. No. 5,445,654, U.S. Pat. No. 5,611,821 and WO 2004/069937 A1. Nevertheless, current ecological and economical needs were not considered sufficiently in the development of the dye mixtures of the prior art.

The present invention is therefore based on the problem of providing new mixtures of reactive dyes that are suitable, especially, for the reproducible black- or navy-blue-dyeing and printing of nitrogen-containing or hydroxyl-group-containing fibre materials and fulfill the above indicated requirements to the highest possible extent.

The present invention accordingly relates to dye mixtures comprising at least one reactive dye of the formula

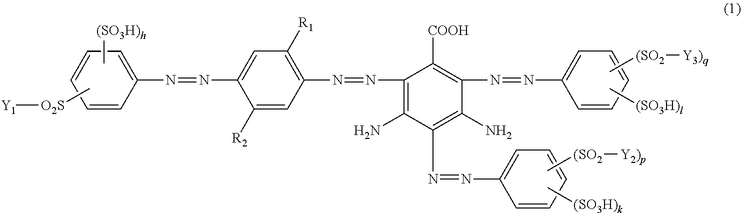

together with at least one reactive dye of the formula

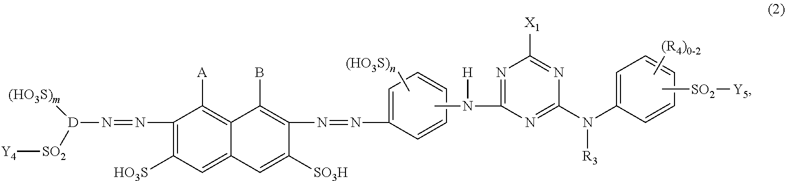

wherein

one of the radicals A and B denotes NH₂, and the other one of the radicals A and B denotes OH,

D is a benzene or naphthalene radical,

R₁ is hydrogen, hydroxy, sulfo, C₁-C₄alkyl or C₁-C₄alkoxy unsubstituted or substituted in the alkyl moiety by hydroxy or by sulfato,

R₂ is hydrogen, C₁-C₄alkyl, C₁-C₄alkoxy, C₂-C₄alkanoylamino or ureido,

R₃ is C₁-C₄alkyl,

(R₄)₀₋₂ denotes 0 to 2 identical or different substituents selected from the group C₁-C₄alkyl, C₁-C₄alkoxy or sulfo,

X₁ is halogen, 3-carboxypyridin-1-yl or 3-carbamoylpyridin-1-yl,

Y₁, Y₂, Y₃, Y₄ and Y₅ are each independently of the other vinyl or a radical —CH₂CH₂—U and U is a group removable under alkaline conditions,

h, k, l, m and n are each independently of the other the number 0, 1 or 2, and

p and q are each independently of the other the number 0 or 1.

Reactive dyes are to be understood as being those which are capable of reacting with the hydroxy groups of cellulose, with the amino, carboxy, hydroxy and thiol groups in wool and silk or with the amino and possibly carboxy groups of synthetic polyamides to form covalent chemical bonds. Reactive dyes contain fibre-reactive radicals which are generally bonded to the dye radical directly or via a bridging member. Fibre-reactive radicals are, for example, those having at least one removable substituent on an aliphatic, aromatic or heterocyclic radical or those wherein the mentioned radicals contain a radical suitable for reaction with the fibre material, for example a vinyl radical.

The dyes of the formulae (1) and (2) in the dye mixtures according to the invention are fibre-reactive and contain one or more than one sulfo groups or carboxy groups, which are each present either in free acid form or, preferably, in salt form. Suitable salts are, for example, alkali metal, alkaline earth metal or ammonium salts, salts of an organic amine, or mixtures thereof. Examples that may be mentioned are lithium, sodium, potassium or ammonium salts, or in the form of a salt of an organic amine, for example, a mono-, di- or tri-ethanolamine salt or mixed Na/Li or Na/Li/NH₄ salts.

As C₁-C₄alkyl there come into consideration for R₁, R₂, R₃ and R₄ each independently of the others, for example, methyl, ethyl, propyl, isopropyl, butyl, sec-butyl, tert-butyl and isobutyl, preferably, methyl and ethyl.

As C₁-C₄alkoxy there come into consideration for R₁, R₂ and R₄ each independently of the others, for example, methoxy, ethoxy, n-propoxy, isopropoxy, n-butoxy and isobutoxy, preferably, methoxy and ethoxy.

As C₁-C₄alkanoylamino there come into consideration for R₂, for example, acetylamino, propionylamino or butyrylamino, preferably, acetylamino.

As halogen there come into consideration for X₁, for example, fluorine, chlorine or bromine, preferably, fluorine or chlorine.

As a group U removable under alkaline conditions there come into consideration, for example, —Cl, —Br, —F, —OSO₃H, —SSO₃H, OCO—CH₃, —OPO₃H₂, —OCO—C₆H₅, —OSO₂—C₁-C₄alkyl and —OSO₂—N(C₁-C₄alkyl)₂. U is preferably a group of formula —Cl, —OSO₃H, —SSO₃H, —OCO—CH₃, —OCO—C₆H₅ or —OPO₃H₂, especially —Cl or —OSO₃H and more especially —OSO₃H.

Examples of suitable radicals Y are accordingly vinyl, β-bromo- or β-chloro-ethyl, β-acetoxy-ethyl, β-benzoyloxyethyl, β-phosphatoethyl, β-sulfatoethyl and β-thiosulfatoethyl. Y is preferably vinyl, β-chloroethyl or β-sulfatoethyl and especially vinyl or β-sulfatoethyl.

Preferably, R₁ is sulfo or C₁-C₄alkoxy unsubstituted or substituted in the alkyl moiety by hydroxy or by sulfato, especially, R₁ is C₁-C₄alkoxy unsubstituted or substituted in the alkyl moiety by hydroxy, for example, methoxy or 2-hydroxyethoxy.

Preferably, R₂ is C₁-C₄alkyl, C₁-C₄alkoxy, C₂-C₄alkanoylamino or ureido, especially, R₂ is C₁-C₄alkyl or C₂-C₄alkanoylamino, for example, methyl or acetylamino.

In a preferred embodiment of the present invention, R₁ is C₁-C₄alkoxy unsubstituted or substituted in the alkyl moiety by hydroxy, and R₂ is C₁-C₄alkyl or C₂-C₄alkanoylamino.

In an especially preferred embodiment of the present invention, R₁ is methoxy and R₂ is methyl, or R₁ is 2-hydroxyethoxy and R₂ is methyl, or R₁ is methoxy and R₂ is acetylamino.

Preferably, R₃ is methyl or ethyl, especially ethyl.

Preferably, (R₄)₀₋₂ denotes hydrogen or one substituent sulfo, especially hydrogen.

Preferably, X₁ is fluorine or chlorine. In one embodiment of the present invention X₁ is chlorine.

Preferably, Y₁, Y₂, Y₃, Y₄ and Y₅ are each independently of the other vinyl or a radical —CH₂CH₂—OSO₃H.

Preferably, h, m and n are each the number 1, and k and l are each independently of the other the number 0 or 1.

The dye of formula (1) in the dye mixtures according to the present invention contains at least two fibre-reactive substituents. Accordingly, the sum of p and q is the number 1 or 2.

Preferably, D is a benzene radical.

Preferably, the dye of the formula (2) is a dye of the formula

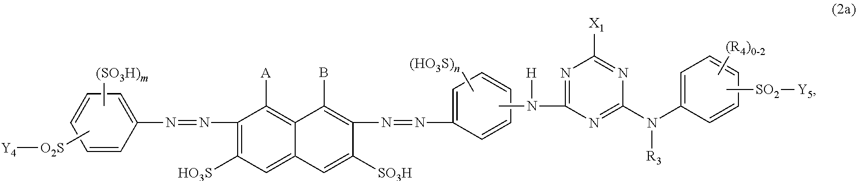

wherein the radicals have the meanings and preferred meanings defined above.

The dyes of formulae (1) and (2) are known in some cases or they can be prepared in accordance with processes known per se. Dyes of the formula (1) are disclosed, for example, in U.S. Pat. No. 6,160,101 and International Application No. PCT/EP2011/050397. Dyes of the formula (2) are disclosed, for example, in U.S. Pat. No. 4,622,390 and U.S. Pat. No. 6,458,936.

The dye of formula (1) is, for example, a dye of the formula

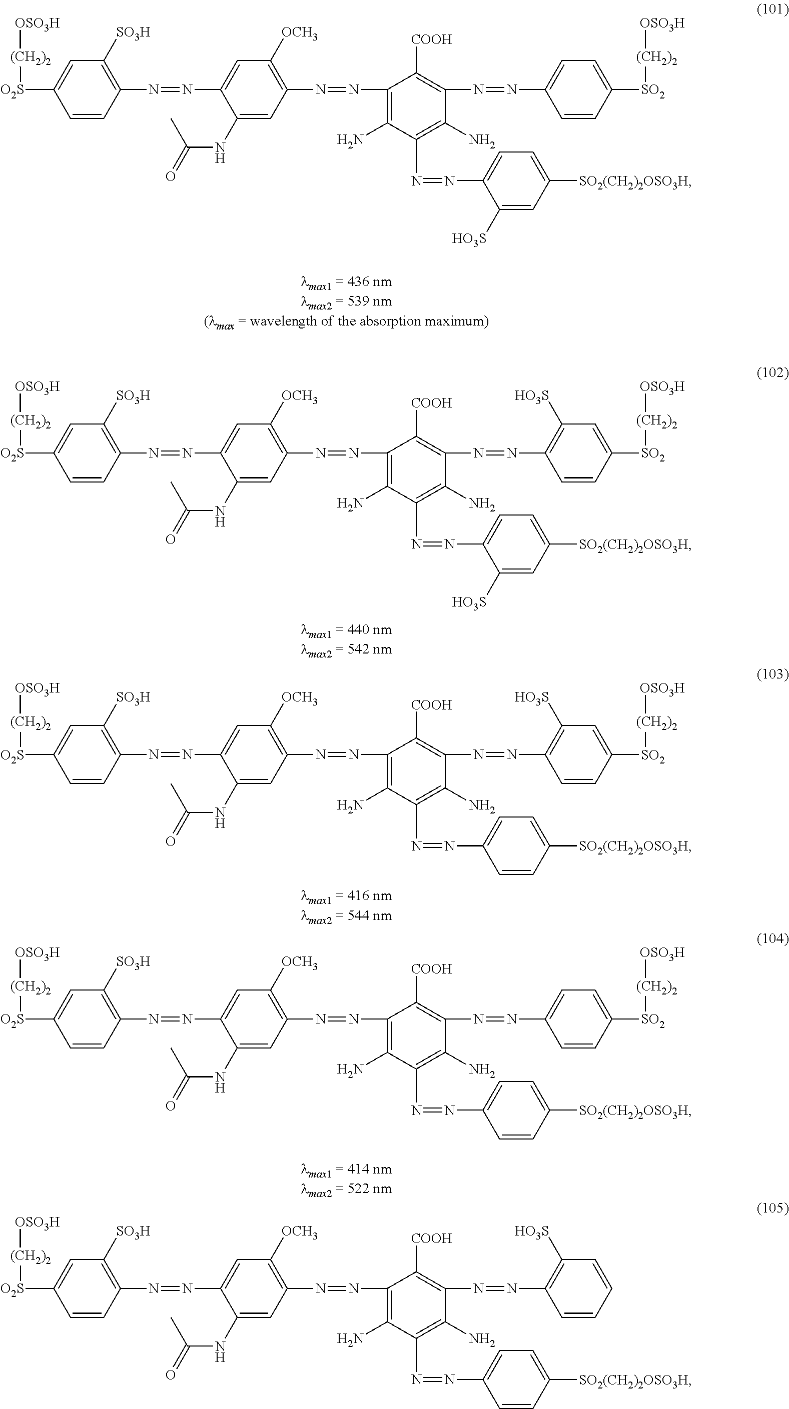

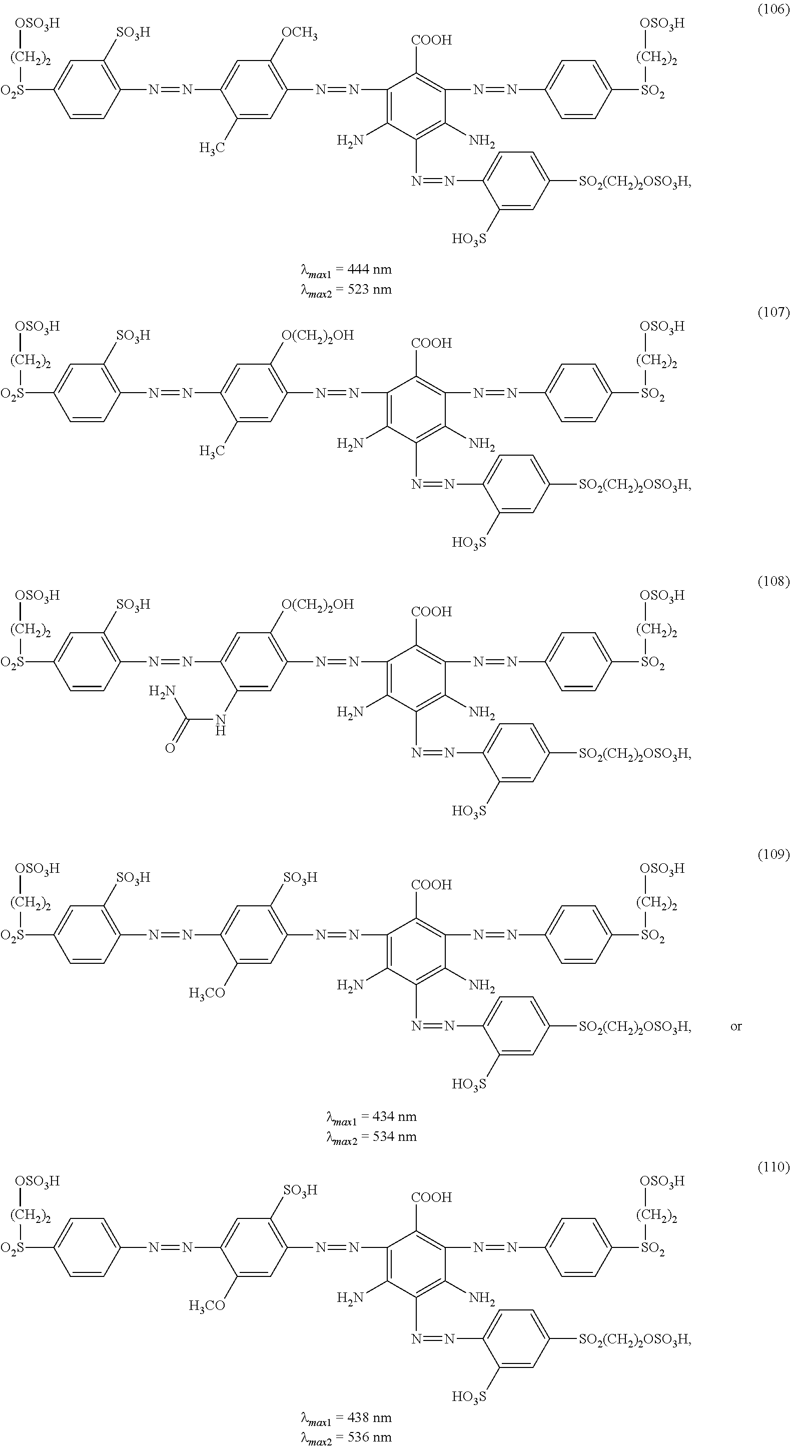

preferably, a dye of the formula (101).

In another embodiment of the present invention the dye of formula (1) is a mixture of the dyes of formulae (101), (102), (103) and (104).

The dye of formula (2) is, for example, a dye of the formula

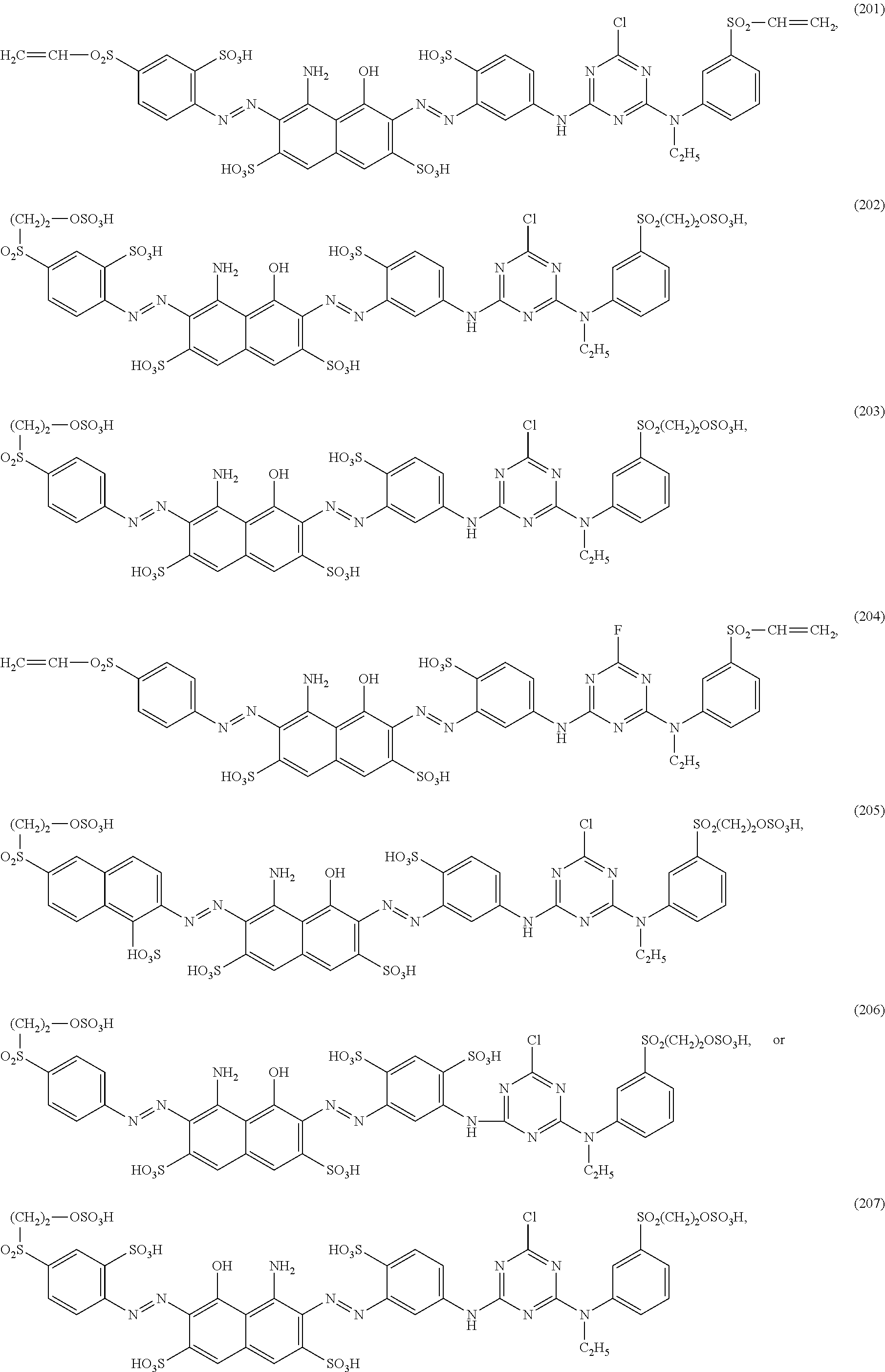

preferably, a dye of the formula (201), (202) or (207).

The dyes of formulae (1) and (2) are present in the dye mixture e.g. in a ratio by weight of from 5:95 to 95:5 and preferably from 10:90 to 90:10 and especially 30:70 to 70:30. In a particular embodiment of the present invention the dyes of formulae (1) and (2) are present in the dye mixture in a ratio by weight of from 40:60 to 60:40.

The dyestuff mixtures according to the present invention may contain further dyestuffs, for example:

at least one of the disazo dyes disclosed in DE 960 534 C, DE 31 13 989 A1, EP 0 063 276 A2 and EP 0 122 600 A1, in particular, C.I. Reactive Black 5, at least one of the dyes selected from the group of dyes disclosed in Example 8 (pages 6 and 7) of DE 960 534 C, at least one of the dyes selected from the group of dyes disclosed in Examples 1, 5, 6, 12, 13, 14, 15 and 16 of EP 0 063 276 A2, at least one of the dyes selected from the group of dyes disclosed in Examples 1, 2, 3, 4, 5 and 6 of EP 0 122 600 A1, or at least one of the dyes selected from the group of dyes disclosed in Examples 1 and 6 of DE 31 13 989 A1, which dyestuffs are herein incorporated by reference;

at least one dye of the formula (1) disclosed in WO 00/06652, or at least one dye of the formula (1) disclosed in European Patent Application No. 11161503.5, in particular, at least one of the dyes selected from the group of dyes disclosed in Examples 26, 49, 63 and 88 of WO 00/06652, or at least one of the dyes selected from the group of dyes disclosed in Examples 4, 5, 6, 7 and 8 of European Patent Application No. 11161503.5, which dyestuffs are herein incorporated by reference;

at least one of the dyes selected from the group of dyes disclosed in Examples 38, 40 and 41 of U.S. Pat. No. 6,160,101, which dyestuffs are herein incorporated by reference; or

at least one of the dyes selected from the group of dyes disclosed in Examples 3 and 30 of U.S. Pat. No. 5,817,779, which dyestuffs are herein incorporated by reference.

The reactive dyes of formulae (1) and (2), and therefore also the dye mixtures, may comprise further additives, for example sodium chloride or dextrin.

The dye mixtures according to the invention can be prepared, for example, by mixing the individual dyes together. That mixing process is carried out, for example, in suitable mills, e.g. ball mills or pin mills, and also in kneaders or mixers.

Some of the dyes of formula (1) are new. Accordingly, the present invention also relates to a reactive dye of the formula

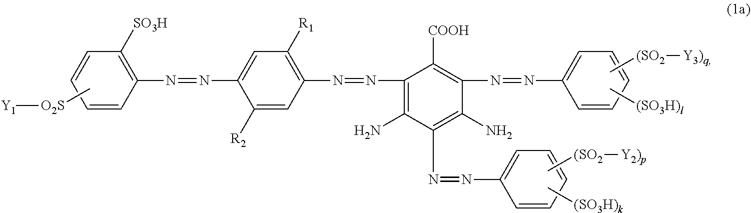

wherein

R₁ is C₁-C₄alkoxy unsubstituted or substituted in the alkyl moiety by hydroxy,

R₂ is C₁-C₄alkyl, C₂-C₄alkanoylamino or ureido,

Y₁, Y₂ and Y₃ are each independently of the other vinyl or a radical —CH₂CH₂—OSO₃H,

k and l are each independently of the other the number 0 or 1,

p and q are each independently of the other the number 0 or 1, and

the sum of p and q is the number 1 or 2, wherein

the dye of the formula

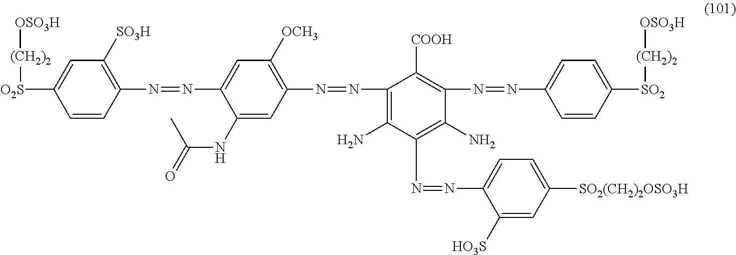

is excluded.

Preferably, R₁ is methoxy or 2-hydroxyethoxy.

Preferably, R₂ is C₁-C₄alkyl or C₂-C₄alkanoylamino, especially, R₂ is methyl or acetylamino.

In a particular embodiment of the present invention the reactive dye of the formula (1a) corresponds to a dye of the formula (102), (103), (104), (105), (106), (107) or (108).

Furthermore, the present invention relates to a reactive dye of the formula

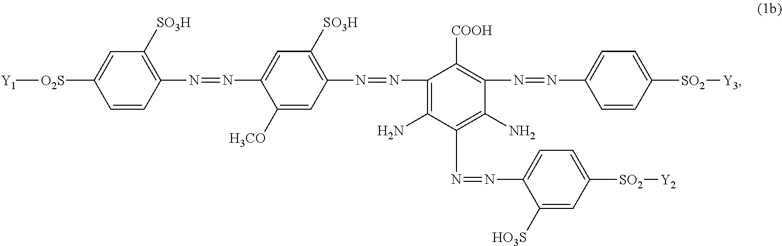

wherein

Y₁, Y₂ and Y₃ are each independently of the other vinyl or a radical —CH₂CH₂—OSO₃H.

The dye mixtures and dyes according to the invention are suitable for dyeing and printing an extremely wide variety of materials, especially hydroxyl-group-containing or nitrogen-containing fibre materials. Examples are paper, silk, leather, wool, polyamide fibres and polyurethanes and also especially cellulosic fibre materials of all kinds. Such fibre materials are, for example, the natural cellulosic fibres, such as cotton, linen and hemp, and also cellulose and regenerated cellulose. The dye mixtures and dyes according to the invention are also suitable for dyeing or printing hydroxyl-group-containing fibres present in blend fabrics, e.g. mixtures of cotton with polyester fibres or polyamide fibres.

The present invention accordingly relates also to the use of the dye mixtures and the dyes according to the invention for the dyeing or printing of hydroxyl-group-containing or nitrogen-containing, especially cellulosic, fibre materials.

The dye mixtures and dyes according to the invention can be applied to the fibre material and fixed to the fibre in a variety of ways, especially in the form of aqueous dye solutions and dye print pastes. They are suitable both for the exhaust process and for dyeing in accordance with the pad-dyeing process; they can be used at low dyeing temperatures and require only short steaming times in the pad-steam process. Dyeing times can be reduced. Furthermore, they have sufficient substantivity and at the same time have good ease of washing off of unfixed dye and can advantageously be applied at short liquor ratios, for example, at a liquor ratio of from 1:4 to 1:6, preferably, 1:6. The dyeings and prints produced in accordance with the method of the invention exhibit very good fastness properties, such as wash and water fastness and perspiration fastness, and good reproducibility.

The dyeings and prints produced using the dye mixtures and dyes according to the invention have a high tinctorial strength and a high fibre-dye binding stability in both the acidic and the alkaline range, as well as good fastness to light and very good wet-fastness properties, such as fastness to washing, to water, to seawater, to cross-dyeing and to perspiration. The dyeings obtained exhibit fibre-levelness and surface-levelness.

The dye mixtures and dyes according to the invention are also suitable as colorants for use in recording systems. Such recording systems are, for example, commercially available inkjet printers for paper or textile printing, or writing instruments, such as fountain pens and ballpoint pens and especially inkjet printers. For that purpose the dye mixture according to the invention is first brought into a form suitable for use in recording systems. A suitable form is, for example, an aqueous ink that comprises the dye mixture or dyes according to the invention as colorant. The inks can be prepared in customary manner by mixing together the individual constituents in the desired amount of water.

Substrates that come into consideration include the above-mentioned hydroxyl-group-containing or nitrogen-containing fibre materials, especially cellulosic fibre materials.

The dyes used in the aqueous inks should preferably have a low salt content, that is to say they should have a total content of salts of less than 0.5% by weight, based on the weight of the dyes. Dyes that have relatively high salt contents as a result of their preparation and/or as a result of the subsequent addition of diluents can be desalted, for example, by membrane separation procedures, such as ultrafiltration, reverse osmosis or dialysis.

The inks preferably have a total content of dyes of from 1 to 35% by weight, especially from 1 to 30% by weight and preferably from 1 to 20% by weight, based on the total weight of the ink. As a lower limit, a limit of 1.5% by weight, preferably 2% by weight and especially 3% by weight, is preferred.

The inks may comprise water-miscible organic solvents, for example C₁-C₄alcohols, such as methanol, ethanol, n-propanol, isopropanol, n-butanol, sec-butanol, tert-butanol and iso-butanol; amides, e.g. dimethylformamide and dimethylacetamide; ketones or ketone alcohols, e.g. acetone and diacetone alcohol; ethers, e.g. tetrahydrofuran and dioxane; nitrogen-containing heterocyclic compounds, e.g. N-methyl-2-pyrrolidone and 1,3-dimethyl-2-imidazolidone; polyalkylene glycols, e.g. polyethylene glycol and polypropylene glycol; C₂-C₆alkylene glycols and thioglycols, e.g. ethylene glycol, propylene glycol, butylene glycol, triethylene glycol, thiodiglycol, hexylene glycol and diethylene glycol; further polyols, e.g. glycerol and 1,2,6-hexanetriol; and C₁-C₄alkyl ethers of polyhydric alcohols, e.g. 2-methoxy-ethanol, 2-(2-methoxyethoxy)ethanol, 2-(2-ethoxyethoxy)ethanol, 2-[2-(2-methoxyethoxy)-ethoxy]-ethanol and 2-[2-(2-ethoxyethoxy)ethoxy]ethanol; preferably N-methyl-2-pyrrolidone, diethylene glycol, glycerol or especially 1,2-propylene glycol, usually in an amount of from 2 to 30% by weight, especially from 5 to 30% by weight and preferably from 10 to 25% by weight, based on the total weight of the ink.

The inks may also comprise solubilisers, e.g. ε-caprolactam.

The inks may comprise thickeners of natural or synthetic origin inter alia for the purpose of adjusting the viscosity.

Examples of thickeners that may be mentioned include commercially available alginate thickeners, starch ethers or locust bean flour ethers, especially sodium alginate on its own or in admixture with modified cellulose, e.g. methylcellulose, ethylcellulose, carboxymethylcellulose, hydroxyethylcellulose, methylhydroxyethylcellulose, hydroxypropyl cellulose or hydroxypropyl methylcellulose, especially with preferably from 20 to 25% by weight carboxymethylcellulose. Synthetic thickeners that may be mentioned are, for example, those based on poly(meth)acrylic acids or poly(meth)acrylamides and also polyalkylene glycols having a molecular weight of e.g. from 2000 to 20 000, for example polyethylene glycol or polypropylene glycol or the mixed polyalkylene glycols of ethylene oxide and propylene oxide.

The inks comprise such thickeners, for example, in an amount of from 0.01 to 2% by weight, especially from 0.01 to 1% by weight and preferably from 0.01 to 0.5% by weight, based on the total weight of the ink.

The inks may also comprise buffer substances, e.g. borax, borates, phosphates, poly-phosphates or citrates. Examples that may be mentioned include borax, sodium borate, sodium tetraborate, sodium dihydrogen phosphate, disodium hydrogen phosphate, sodium tripolyphosphate, sodium pentapolyphosphate and sodium citrate. They are used especially in amounts of from 0.1 to 3% by weight, preferably from 0.1 to 1% by weight, based on the total weight of the ink, in order to establish a pH value of, for example, from 4 to 9, especially from 5 to 8.5.

As further additives, the inks may comprise surfactants or humectants.

Suitable surfactants include commercially available anionic or non-ionic surfactants. As humectants in the inks according to the invention there come into consideration, for example, urea or a mixture of sodium lactate (advantageously in the form of a 50% to 60% aqueous solution) and glycerol and/or propylene glycol in amounts of preferably from 0.1 to 30% by weight, especially from 2 to 30% by weight.

Preference is given to inks having a viscosity of from 1 to 40 mPa·s, especially from 1 to 20 mPa·s and preferably from 1 to 10 mPa·s.

The inks may also comprise customary additives, such as antifoam agents or especially preservatives that inhibit the growth of fungi and/or bacteria. Such additives are usually used in amounts of from 0.01 to 1% by weight, based on the total weight of the ink.

Preservatives that come into consideration include formaldehyde-yielding agents, e.g. paraformaldehyde and trioxane, especially aqueous, approximately 30 to 40% by weight formaldehyde solutions, imidazole compounds, e.g. 2-(4-thiazolyl)benzimidazole, thiazole compounds, e.g. 1,2-benzisothiazolin-3-one or 2-n-octyl-isothiazolin-3-one, iodine compounds, nitriles, phenols, haloalkylthio compounds or pyridine derivatives, especially 1,2-benzisothiazolin-3-one or 2-n-octyl-isothiazolin-3-one. A suitable preservative is e.g. a 20% by weight solution of 1,2-benzisothiazolin-3-one in dipropylene glycol (Proxel® GXL).

The inks may also comprise further additives, such as fluorinated polymers or telomers, e.g. polyethoxyperfluoroalcohols (Forafac® or Zonyl® products) in an amount of e.g. from 0.01 to 1% by weight, based on the total weight of the ink.

In inkjet printing, individual droplets of the ink are sprayed onto a substrate in a controlled manner from a nozzle. For this purpose, predominantly the continuous inkjet method and the drop-on-demand method are used. In the continuous inkjet method, the droplets are produced continuously and any droplets not required for the printing are conveyed to a collecting vessel and recycled, whereas in the drop-on-demand method droplets are produced and printed as required; that is to say droplets are produced only when required for the printing. The production of the droplets can be effected, for example, by means of a piezo-inkjet head or by means of thermal energy (bubble jet). Printing by means of a piezo-inkjet head and printing in accordance with the continuous inkjet method are preferred.

The present invention accordingly relates also to aqueous inks comprising the dye mixtures or dyes according to the invention and to the use of such inks in an inkjet printing method for the printing of various substrates, especially textile fibre materials, the definitions and preferred meanings mentioned above applying to the dye mixtures, the dyes, the inks and the substrates.

The following Examples serve to illustrate the invention. Unless otherwise indicated, the temperatures are given in degrees Celsius, parts are parts by weight and percentages relate to % by weight. Parts by weight relate to parts by volume in a ratio of kilograms to litres.

### SYNTHESIS EXAMPLE 1

### a) 1^{st} Coupling

162.5 g (0.45 mol) of 2-sulfo-4-(2-sulfatoethylsulfonyl)-aniline are introduced into 700 ml water and the mixture is stirred thoroughly. First 56 ml of a 32% hydrochloric acid and then 100 ml of a 4N sodium nitrite solution are added within 10 min to the suspension at 10° C. After warming up to room temperature (RT) further 15 ml of a 4N sodium nitrite solution are added. The mixture is stirred for 30 min and the excess nitrite is destroyed by addition of 2.0 ml of 10% sulfamic acid.

61.8 g (0.45 mol) of 2-methoxy-5-methylaniline are introduced into 500 ml water under vigorous stirring. 54.2 ml of 32% hydrochloric acid are added and the mixture is stirred at 20-25° C. until the amine dissolves. Subsequently, 51.9 ml of 30% aqueous sodium hydroxide are added and a fine suspension is obtained, which is cooled to 0° C. with ice. To this suspension the dispersion of the diazonium salt is added within 30 min at 0-5° C., while pH 4 is kept by addition of NaOH. Afterwards, the mixture is allowed to warm to 20° C.

### b) 2^{nd} Coupling

To the suspension of the azo compound obtained in step a) there are added 112 ml of a 4N sodium nitrite solution and at 20° C. 120 ml 32% hydrochloric acid. The mixture is stirred for 30 min at 20-30° C. and the excess nitrite is destroyed by addition of 2.0 ml of 10% sulfamic acid. The suspension of the diazonium salt is cooled down to 5° C. by addition of 600 g ice. A solution of 60.9 g (0.40 mol) of 3,5-diaminobenzoic acid are dissolved in 500 ml water and 44 ml 32% hydrochloric acid is added within 10 min. Subsequently, 322 ml of a 20% sodium carbonate solution are added within 4 h, pH=3.9.

### c) 3^{rd} Coupling

171 g (0.47 mol) of 2-sulfo-4-(2-sulfatoethylsulfonyl)-aniline are introduced into 800 ml water and the mixture is stirred thoroughly. First 85 ml of a 32% hydrochloric acid and then 100 ml of a 4N sodium nitrite solution are added within 10 min to the suspension at 10° C. After warming up to room temperature (RT) further 19 ml of a 4N sodium nitrite solution are added. The mixture is stirred for 30 min and the excess nitrite is destroyed by addition of 2.0 ml of 10% sulfamic acid.

The suspension prepared in step b) is cooled down to 10° C. by addition of 400 g ice and the suspension of the diazonium salt is added within 35 min. Subsequently, 318 ml of a 20% sodium carbonate solution are added within 4 h, pH=7.0.

### d) 4^{th} Coupling

The suspension prepared in step c) is cooled down to 10° C. by addition of ice and a suspension containing 0.4 mol of the diazonium salt prepared from 4-(2-sulfatoethylsulfonyl)-aniline as described in step a) is added within 20 min. Subsequently, 147 ml of a 20% sodium carbonate solution are added within 90 min, pH=6.7.

The crude solution is filtered and spray-dried. The resulting powder consists of the dye of the formula

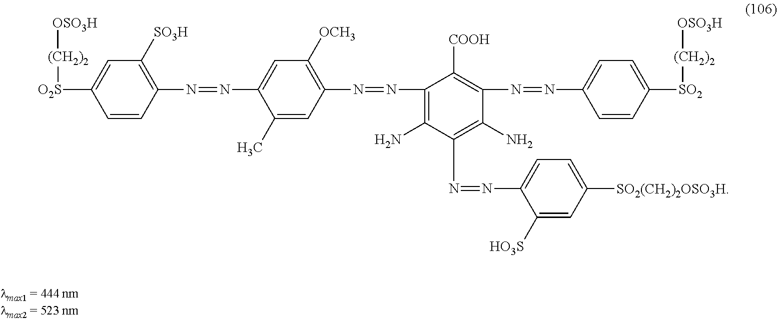

The dyes of the formulae (102), (103), (104), (105), (107), (108) and (109) are prepared in analogy to the procedure described in Synthesis Example 1.

### EXAMPLE 1

A cotton tricot fabric is introduced at 60° C. into an aqueous dyebath with a liquor ratio of 1:6 which contains a black dyeing dyestuff mixture containing 60.0 parts of a dye of the formula (101) and 40.0 parts of a dye of the formula (201), and sodium chloride in the amounts as indicated in Table 1.

TABLE 1
Composition of dyebaths 1 to 6 containing the
black dyeing dyestuff mixture

| | dyebath | | | | | |
|---|---|---|---|---|---|---|
| | 1 | 2 | 3 | 4 | 5 | 6 |
| %* of dyestuff mixture | 0.5 | 1.0 | 2.0 | 4.0 | 6.0 | 8.0 |
| sodium chloride [g/l] | 30 | 40 | 50 | 70 | 80 | 80 |
| sodium carbonate [g/l] | 12 | 14 | 16 | 20 | 20 | 20 |

*% of dyestuff is with respect to the weight of the cotton fabric

After 45 minutes at 60° C. calcined sodium carbonate is added in the amount given in Table 1. Dyeing is continued for 45 minutes. The dyed goods are then rinsed with water, soaped and rinsed again and then dried.

The tinctorial strengths of the dyeings obtained with the dyeing liquors 1 to 6 are measured photospectrometrically. Build-up properties are shown in Table 2.

TABLE 2
Build-up: dependence of reference depth (RD)
from dyestuff concentration

| | % of dyestuff mixture | | | | | | |
|---|---|---|---|---|---|---|---|
| | 0 | 0.5 | 1.0 | 2.0 | 4.0 | 6.0 | 8.0 |
| RD dyestuff of Ex 1 | 0 | 0.62 | 1.23 | 2.09 | 3.50 | 4.02 | 4.25 |

### EXAMPLE 2

A black dyed cotton tricot fabric with a reference depth (RD) of 3.08 is obtained by dyeing in accordance with the process described in Example 1, but using 3.18% of the black dyeing dyestuff mixture of Example 1, 60 g/l of sodium chloride, and 18 g/l of sodium carbonate. The dyed fabric is subjected to the following wash treatment:
(a) washed twice for 10 minutes at 25° C.;
(b) fabric treated according to step (a) additionally washed for 20 minutes at 80° C. in the presence of 2 g/l TINOVETIN®JU;
(c) fabric treated according to step (b) additionally washed for 15 minutes at 70° C.;
(d) fabric treated according to step (c) additionally washed for 20 minutes at 40° C.;
(e) fabric treated according to step (c) additionally washed for 20 minutes at 40° C. in the presence of 2% TINOFIX® ECO (pH 6).

The washed fabric is subjected to the following colour fastness tests: Wash at 60° C. according to ISO 105-006, CIS, and Water severe according to ISO 105-E01. Canges in colour are determined according to the Grey Scale. Higher ratings indicate superior fastness properties. The results in Table 3 demonstrate that the dyed fabrics exhibit good fastness properties.

TABLE 3
Fastness properties

| | Wash at 60° C.* | | Water severe** | |
|---|---|---|---|---|
| Wash treatment | (d) | (e) | (d) | (e) |
| CO | 4 | 4-5 | 5 | 5 |
| PA 6.6 | 5 | 5 | 4-5 | 5 |

*Wash at 60° C. according to ISO 105-C06, C1S;
*Water severe according to ISO 105-E01

### EXAMPLE 3

A cotton tricot fabric is introduced at 60° C. into an aqueous dyebath with a liquor ratio of 1:6 which contains a black dyeing dyestuff mixture containing 55.42 parts of a dye of the formula (101), 38.63 parts of a dye of the formula (201), and 5.95 parts of a dye of the formula

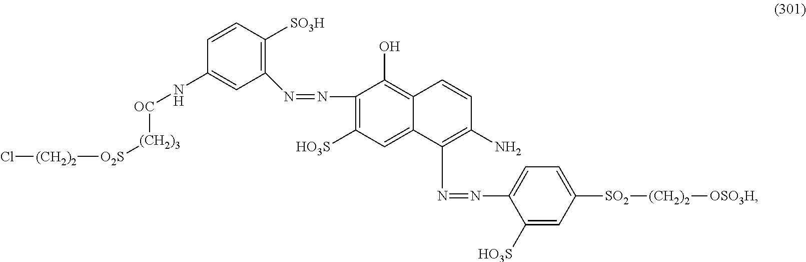

and sodium chloride in the amounts as indicated in Table 1 of Example 1. The dye of formula (301) is described in European Patent Application No. 11161503.5.

After 45 minutes at 60° C. calcined sodium carbonate is added in the amount given in Table 1 of Example 1. Dyeing is continued for 45 minutes. The dyed goods are then rinsed with water, soaped and rinsed again and then dried.

The tinctorial strengths of the dyeings obtained with the dyeing liquors 1 to 6 are measured photospectrometrically. Build-up properties are shown in Table 4.

TABLE 4
Build-up: dependence of reference depth
(RD) from dyestuff concentration

| | % of dyestuff mixture | | | | | | |
|---|---|---|---|---|---|---|---|
| | 0 | 0.5 | 1.0 | 2.0 | 4.0 | 6.0 | 8.0 |
| RD dyestuff of Ex 1 | 0 | 0.53 | 1.10 | 1.93 | 3.38 | 3.97 | 4.16 |

### EXAMPLE 4

A cotton tricot fabric is introduced at 60° C. into an aqueous dyebath with a liquor ratio of 1:6 which contains a black dyeing dyestuff mixture containing 40.0 parts of a dye of the formula (101), 30.0 parts of a dye of the formula (201), and 30 parts of C.I. Reactive Black 5, and sodium chloride in the amounts as indicated in Table 1 of Example 1.

After 45 minutes at 60° C. calcined sodium carbonate is added in the amount given in Table 1 of Example 1. Dyeing is continued for 45 minutes. The dyed goods are then rinsed with water, soaped and rinsed again and then dried.

The tinctorial strengths of the dyeings obtained with the dyeing liquors 1 to 6 are measured photospectrometrically. Build-up properties are shown in Table 5.

TABLE 5
Build-up: dependence of reference depth (RD)
from dyestuff concentration

| | % of dyestuff mixture | | | | | | |
|---|---|---|---|---|---|---|---|
| | 0 | 0.5 | 1.0 | 2.0 | 4.0 | 6.0 | 8.0 |
| RD dyestuff of Ex 1 | 0 | 0.76 | 1.45 | 2.59 | 4.25 | 4.74 | 5.01 |

### EXAMPLE 5

Example 4 is repeated but using instead of the black dyeing dyestuff mixture described in Example 4 a black dyeing dyestuff mixture consisting of 70.0 parts of a dye of the formula (101), 15.0 parts of a dye of the formula (201), and 15 parts of C.I. Reactive Black 5. Build-up properties are shown in Table 6.

TABLE 6
Build-up: dependence of reference depth (RD)
from dyestuff concentration

| | % of dyestuff mixture | | | | | | |
|---|---|---|---|---|---|---|---|
| | 0 | 0.5 | 1.0 | 2.0 | 4.0 | 6.0 | 8.0 |
| RD dyestuff of Ex 1 | 0 | 0.68 | 1.21 | 2.35 | 3.68 | 4.23 | 4.45 |

Printing Procedure:

(a) Mercerised cotton-satin is padded using a liquor containing 30 g/l of sodium carbonate and 50 g/l of urea (liquor uptake 70%) and dried.

(b) The cotton-satin pre-treated according to Step (a) is printed using an aqueous ink containing
15% by weight of a black dyeing dyestuff mixture consisting of 60.0 parts of a dye of the formula (101) and 40.0 parts of a dye of the formula (201),
15% by weight of 1,2-propylene glycol and
70% by weight of water

using a drop-on-demand inkjet head (bubble jet). The print is dried completely and fixed in saturated steam at 102° C. for 8 minutes, cold-rinsed, washed off at the boil, rinsed again and dried.

1. A dye mixture comprising at least one reactive dye of the formula 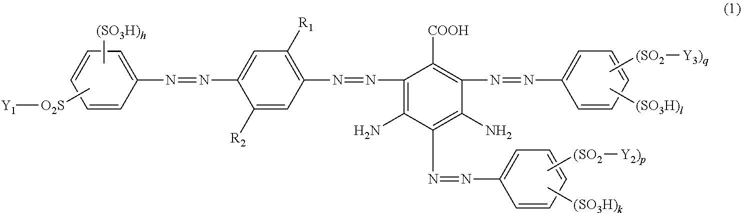
together with at least one reactive dye of the formula 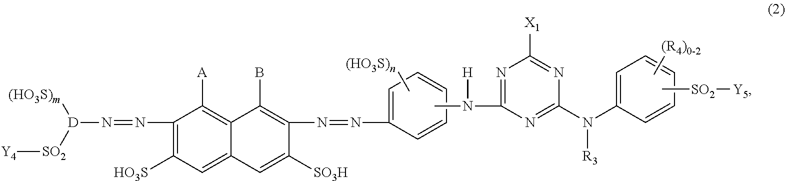
wherein
one of the radicals A and B denotes NH₂, and the other one of the radicals A and B denotes OH,
D is a benzene or naphthalene radical,
R₁ is hydrogen, hydroxy, sulfo, C₁-C₄ alkyl or C₁-C₄ alkoxy unsubstituted or substituted in the alkyl moiety by hydroxy or by sulfato,
R₂ is hydrogen, C₁-C₄ alkyl, C₁-C₄alkoxy, C₂-C₄ alkanoylamino or ureido,
R₃ is C₁-C₄ alkyl,
(R₄)₀₋₂ denotes 0 to 2 identical or different substituents selected from the group C₁-C₄ alkyl, C₁-C₄ alkoxy or sulfo,
X₁ is halogen, 3-carboxypyridin-1-yl or 3-carbamoylpyridin-1-yl,
Y₁, Y₂, Y₃, Y₄ and Y₅ are each independently of the other vinyl or a radical —CH₂CH₂—U and U is a group removable under alkaline conditions,
h, k, l, m and n are each independently of the other the number 0, 1 or 2, and
p and q are each independently of the other the number 0 or 1.

2. A dye mixture according to claim 1, wherein
R₁ is C₁-C₄ alkoxy unsubstituted or substituted in the alkyl moiety by hydroxy, and
R₂ is C₁-C₄ alkyl or C₂-C₄ alkanoylamino.

3. A dye mixture according to claim 1, wherein R₃ is methyl or ethyl.

4. A dye mixture according to claim 1, wherein (R₄)₀₋₂ denotes hydrogen or one substituent sulfo.

5. A dye mixture according to claim 1, wherein X₁ is fluorine or chlorine.

6. A dye mixture according to claim 1, wherein Y₁, Y₂, Y₃, Y₄ and Y₅ are each independently of the other vinyl or a radical —CH₂CH₂—OSO₃H.

7. A dye mixture according to claim 1, wherein h, m and n are each the number 1, and k and l are each independently of the other the number 0 or 1.

8. A dye mixture according to claim 1, wherein D is a benzene radical.

9. A method for the dyeing or printing of hydroxyl-group-containing or nitrogen-containing fibre materials comprising applying the dye mixture according to claim 1 to the hydroxyl-group-containing fibre material or nitrogen-containing fibre material.

10. The method according to claim 9, wherein the hydroxyl-group-containing fibre material is cellulosic fibre material.

11. The reactive dye of the formula 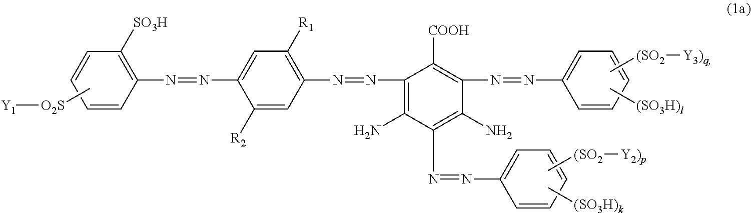
wherein
R₁ is C₁-C₄ alkoxy unsubstituted or substituted in the alkyl moiety by hydroxy,
R₂ is C₁-C₄ alkyl, C₂-C₄ alkanoylamino or ureido,
Y₁, Y₂ and Y₃ are each independently of the other vinyl or a radical —CH₂CH₂—OSO₃H,
k and l are each independently of the other the number 0 or 1,
p and q are each independently of the other the number 0 or 1, and
the sum of p and q is the number 1 or 2, wherein
the dye of the formula 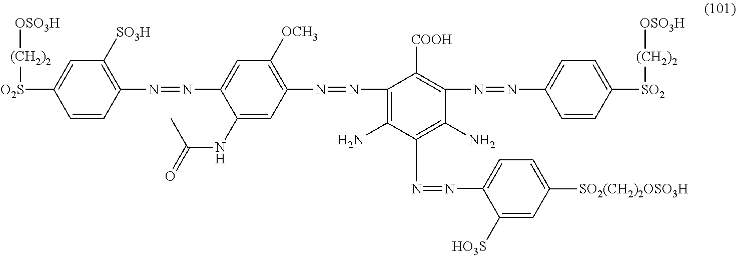
is excluded.

12. The reactive dye of the formula 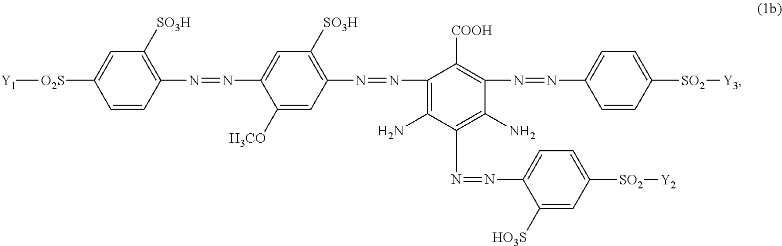
wherein Y₁, Y₂ and Y₃ are each independently of the other vinyl or a radical —CH₂CH₂—OSO₃H.
